(19) United States
(12) Patent Application Publication
(10) Pub. No.: US 2003/0169299 A1
(43) Pub. Date: Sep. 11, 2003

(54) Dormant GUI buttons reside unobtrusively in the background upon selection

(76) Inventors: Mieko Kusano, Cambridge, MA (US); Robert Lambourne, Cambridge, MA (US); Lisa Holzhauser, San Carlos, CA (US)

Correspondence Address: Corporate Patent Counsel, Philips Electronics North America Corporation, 580 White Plains Road, Tarrytown, NY, 10591, US

(21) Appl. No.: 10/092,847

(22) Filed: Mar. 5, 2002

(51) Int. Cl. G09G 5/00

(52) U.S. Cl. 345/810

(57) ABSTRACT

The invention relates to a GUI for enabling a user to navigate between a wide variety of options. With the trend of offering more applications and options to the user, like in STB's deployed in a living room, it becomes evident to present the options in an intuitive and user friendly manner. Only user options are selectable, on e.g. a TV screen, which are currently of direct interest to the user. The user can navigate between these options using, e.g., a relative simple input device like a RC. Other options are shown semi visible in the background and are like in a dormant state. With e.g. a separate button on the input device these options can be made completely visible and can even be emphasized using, e.g., an animation on the screen. The invention is especially well suited for in a data driven applications environment.

### FIELD OF THE INVENTION

This invention relates to a Graphical User Interface (GUI) design suitable for applications on devices such as a Set Top Box (STB) and a PC. In particular the invention relates to a presentation and selection method of user selectable options using 2.5D and 3D spatial effects.

### PRIORITY DATE

The invention claims priority to an earlier filed patent application (U.S. Ser. No. 09/801,070, filed Mar. 6, 2001; attorney docket S/N US 018022) now abandoned. That invention has an identical description and an identical set of claims.

### BACKGROUND ART

In a STB the number of available Software-applications (SW) and user-selectable options are ever increasing in every new generation. Using buttons with focus and a Remote Control (RC), the user can select an option using, e.g., a moving highlight. As the number of options increases the user starts losing the overview. This problem only worsens when operating in an open networked environment where devices can be added or disconnected and where the GUI changes accordingly.

### SUMMARY OF THE INVENTION

The invention relates to a GUI design in which solutions are offered for dealing with an increased number of options while keeping it easy for the user to control the options.

This invention proposes a user-intuitive GUI design with easy-to-select options that let the user keep the overview, even with an extended functionality.

The communication between networked devices can be the responsibility of a STB in the network. The emphasis of the networked system will be on the content as perceived by the user and less on the devices themselves i.e., content-centric instead of device-centric. In a networked environment it can be advantageous to collect data that is descriptive of content information available at various resources on the network. This data can be combined in a single menu to enable the user to select from the content, regardless of the resource.

The GUI design as of the current invention is very much suited to take advantage of the approach of a data management system, which can collect the data as described above. An example of such a data management system is described in patent application U.S. Ser. No. 09/568,932 (attorney docket US 000106), incorporated by reference in its entirety herein.

Personalization of content and its contextual filtering are becoming more prevalent. The proposed GUI of the invention has been developed with content driven applications in mind.

Using the GUI design and approach of this invention, new components can easily be added in the GUI, such as a GUI representation of a newly attached networked device. Examples of SW-protocols for a network where attaching/detaching a device is allowed are HAVI, UPnP and Jini. Methods and rules for data-driven applications can apply to more than one device. If, e.g., the user wants to play a certain piece of music on his/her home entertainment system he/she is in general less interested from which device it originates. Therefore the graphical presentation of various playback functions can be the same for, e.g., an MP3 player and a CD-player.

The invention is explained in more detail by using an example of a GUI for a virtual audio-jukebox application. The expression “virtual” in this context refers to that all the songs seem part of one-and-the-same audio-jukebox to the user. In reality the songs can reside in different physical devices such as a CD-player or an MP3-player. These players can be part of a (digital) networked home system. The application can easily be expanded to include multiple forms of digital content (e.g. movies etc.). The GUI of the application is also able to present feedback to the user when he/she interacts with a physical object, as in this example a CD-player. The concrete notion of the physical CD-player is combined in the GUI with the abstract notion of digital information, in this case digital audio. Choosing a familiar metaphor (in this example a stack of CDs is used) simplifies the usability and structures the relationship between the medium (in this example music), the application and the user. The content and control can come however from different sources. The networked home system will typically have a certain degree of awareness of its networked devices.

A typical Television (TV) screen is considered as a device, which provides the visual user information. The GUI screenshots used to illustrate this invention have been made with a TV screen in mind. But the invention is also applicable to other types of screens, such as that of web-pads or hand-held devices. Since the user is typically located about 7˜10 feet from the TV-screen (2˜3 m) it is necessary that GUI objects are larger than those used on a computer screen. Therefore less effective space is available for the GUI and a deeper navigation structure is required. As a consequence the GUI is designed with only those tools prominently visible on the screen that are pertinent to the specific task the user is engaged in. The user can control the application using a simple 4-way directional remote control (with an “OK”-button for confirming a selection) and possibly another input device for text input (e.g., using a physical or virtual keyboard). This as opposed to a computer environment where a full-fledged keyboard and a mouse are commonly used as user control means. The invention however also applies to other types of user control means such as based on a joystick with a GUI cursor, speech, etc.

One aspect of the invention is the usage of a graphical emphasis on user options, which are currently relevant to the user and thus must have focus.

User options that have focus in this context mean those options that currently need the attention of the user, e.g., when the user has to choose one song out of a list of ten. In this example the ten songs have focus and get the graphical emphasis. For instance the graphical designer can make use of a higher contrast, a larger object size or more saturated colors or provide more (e.g., textual) information (or a combination of the before mentioned) for options that have focus. The graphical designer can also make use of 2.5D or 3D effects. For example, currently relevant options could be designed such that they appear to ‘pop-out’ of the background so that they appear closer to the user.

User options that have focus are typically of a certain type, e.g., all play-related options for audio such as play, fast-forward, record, stop, fast-backwards or, e.g., a list of songs from which a selection can be made, etc. It is also sometimes possible that more than one type of user options have focus at the same time.

Another method to deal with many options and buttons on a GUI is to enlarge them when the user needs to select a desired function, e.g., in a sub-menu. The sub-menu, in this context, can comprise one or more user selectable options. In case the sub-menu comprises more than one user selectable options, these options are usually of a similar type or are grouped for other specific reasons. This method of enlarging options and buttons on a GUI is described in patent application U.S. Ser. No. 09/062,364 (attorney docket PHA 23,387), incorporated by reference in its entirety herein.

Another aspect of the invention is that user options, which are currently not relevant to the user, can be less explicitly shown in the GUI. For instance the graphical designer can make use of lower contrast, smaller object size or provide, at most, limited additional information (e.g., by using fewer textual or non-textual details) for options that do not have focus. Using animations, e.g., by 2.5D or 3D effects, the graphical designer can also make use of dynamical effects to make options unobtrusive (or even hide options) that have lost focus. Animation is a simulation of movement created by displaying a series of bitmaps. The animation lets the user perceive the change as a smooth transition. Thus the impression is avoided of an abrupt confrontation with a new layout. Further information about animations is found in patent application U.S. Ser. No. 09/128,839 (PHA attorney docket 23,469), incorporated by reference in its entirety herein. For example the GUI can have a panel with a set of options that loses focus, flip around such that the rear side, with a different set of options, gets the focus. The options that have lost focus can become completely invisible or remain partly visible with, e.g., a limited size, less contrast, semi-transparent with its background etc. In another example, the graphical designer might choose to use a pictorial representation (e.g., an icon) for options that have lost focus. An icon can be a metaphoric representation of the sub-menu. In yet another example, the graphical designer might choose to use the background art or background motive as a graphical representation for options that have lost focus. Especially in the latter example, animation can be used as a way to show the transition between the prominent an unobtrusive manner of displaying the user options that have lost focus. A combination of any of the techniques described before, to show user options less explicitly, is envisioned as well.

Yet another aspect of the invention is that user options which get focus can emerge from the background and become bigger or get more contrast or get more detailed with, e.g., additional textual information. Since the options were already shown in an unobtrusive way on the GUI, the user had already notion of their existence. Another advantage of this GUI is that options, which have focus, can make very effective use of the limited screen real estate, thus making them effective and easy to use.

Vice versa, options that lose user focus can submerge from the foreground into the background and can, e.g., become semi-transparent, etc. In other words, options that lose focus become less intrusive or unobtrusive. An advantage to have these options still visible in the background is to give the user the notion that they are still available at a later stage. Typically the possibility that those options will be needed soon again is large.

Menu options are distributed and designed in a nested menu, e.g., in a hierarchy of (sub-) menus. Different levels of hierarchy are represented in different graphical manners so as to let user concentrate on a (sub-) menu with the most focus, but with a previous menu level (and possibly next menu level) present with less focus.

### BRIEF DESCRIPTION OF THE DRAWINGS

The invention is explained using some schematic diagrams of an input device and some GUI screenshots, by way of an example, and with reference to the accompanying drawing wherein:

FIG. 1 is a diagram of a remote control, which can be used as a user input device according to this invention.

FIG. 2 is a schematic diagram illustrating a GUI screenshot with some elements that have a strong sense of place.

FIG. 3 is a schematic diagram illustrating a GUI screenshot with elements that have lost focus.

FIG. 4 is a schematic diagram illustrating a GUI screenshot when content is being played.

FIG. 5 is a schematic diagram illustrating a GUI screenshot with the palette tool flipped around.

FIG. 6 is a schematic diagram illustrating a GUI screenshot with highlighted function menu.

FIG. 7 is a schematic diagram illustrating a GUI screenshot of the function Web store with some deeper level user options.

### DETAILED DESCRIPTION OF THE DRAWINGS

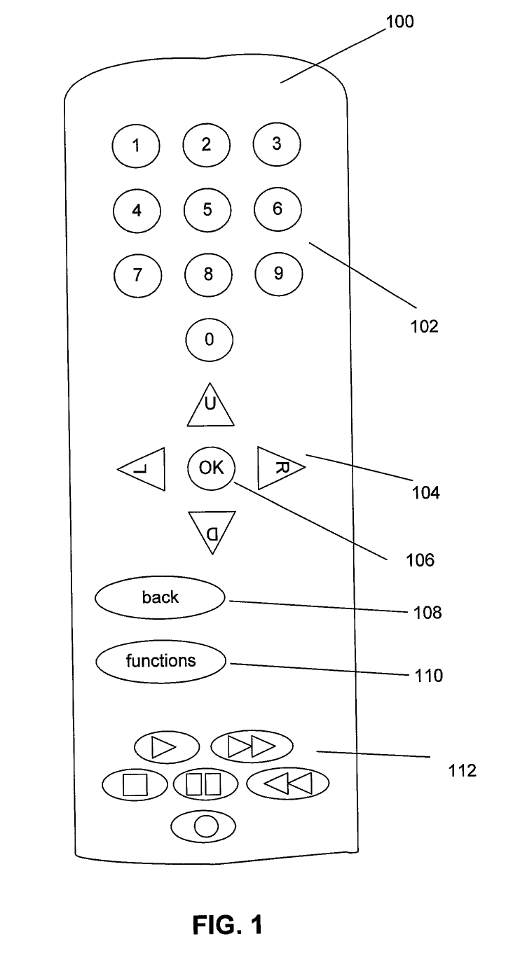

FIG. 1 is a schematic diagram illustrating a RC 100, which can be used as a user input device according to this invention. RC 100 comprises a numerical keypad 102, which can be used for direct digit entry, e.g., for CD track selection. It also comprises a cursor control keypad 104 (with Up, Down, Right and Left keys) and an OK button 106. By using the keypad 104 the user can, e.g., navigate, over GUI highlights on a TV screen, to a desired option. The ’OK’-button 106 can be pushed to express the user's choice after arriving at the desired option. The user, to navigate back to a previous GUI screen and/or user option(s) screen, can use a back button 108. Button functions 110 can be used by the user, e.g., to activate the displaying of certain functions. Because of the very constrained screen area for the GUI, on, e.g., a TV screen, certain functions can not be shown, at least not in full exposure, at all times.

Transport controls 112 can be used by the user to facilitate actual enjoying a music collection.

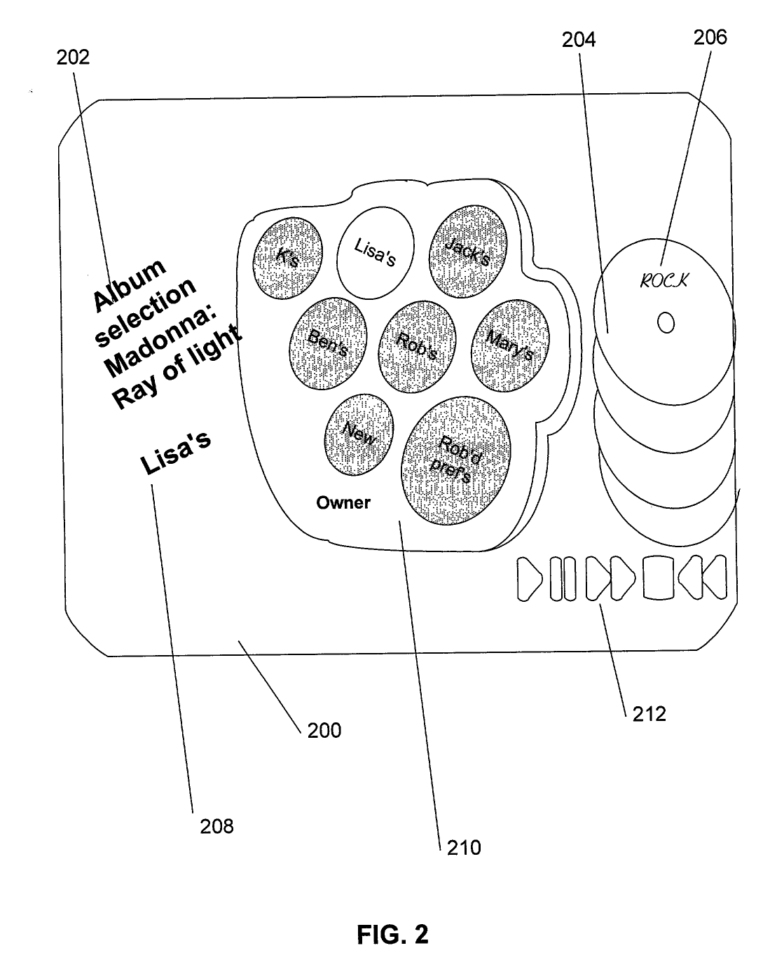

FIG. 2 is a schematic diagram illustrating GUI screenshot 200 with some elements that have a strong sense of place. Parts of screenshot 200 are a text feedback 202, a physical anchor 204, a genre 206, an owner 208, a palette tool 210 and a transport indicator 212.

Because of the spatial constraints of this type of interface (i.e., most of all content exists visually on a single screen) it is very important for the user to have a strong sense of place and a sure sense of where they are in the interface. To provide this, two main anchors exist in GUI screenshot 200 to provide the user with text feedback 202 (e.g., album selection: Madonna “Ray of Light”) in addition to physical anchor 204. Using physical anchor 204 the GUI designer tries to show the user a metaphor of a physical music collection (a stack of CDs is shown). As CDs are selected from the stack, their title or other relevant information can be displayed in the upper left corner as text feedback 202.

Another key element of the user interface is the management of the relationship between the owner of the collection and the genre or category of music (e.g., rock, jazz, opera, etc . . . ). Because the music collection can be divided in groups, such as by the owner, it is very important for the user to be able to control the resulting views smoothly and independently. It can be divided according to ownership, illustrated by owner 208, but also according to genre (with the ability to create customized genres). Although the music can be divided using numerous criterions, in this example only two types of divisions are used. It is noted that the division of the music collection can contain overlaps.

Because of the relationship between owners and genres, the palette tool 210 is actually two-sided in the described example. By e.g., using animation, the flipping between the sides can be visualized thereby giving the user a strong sense of existence of both sides and thus of the relationship. The user can, in the example, flip the palette from owner and get the genre palette side.

Another key element of the user interface is the omnipresence of the transport indicator 212 (i.e., play, pause, fast forward, stop, and rewind). Because the most important reason to have this interface is to facilitate users actually enjoying their music collection, at all times the user must have the ability to play music.

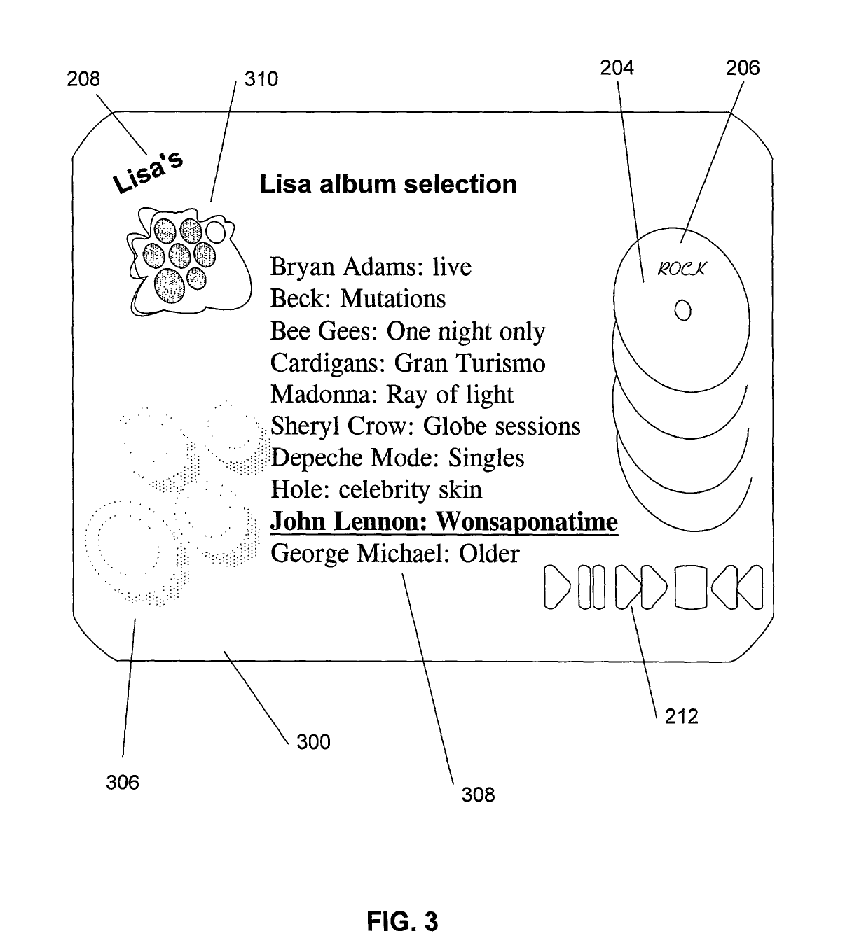

FIG. 3 is a schematic diagram illustrating a GUI screenshot 300 with elements that have lost focus. Parts of screenshot 300 are a lost focus palette tool 310, a physical anchor 204, a genre 206, an owner 208, unobtrusive tool buttons 306, a user selection 308 and a transport indicator 212.

Certain elements of the GUI are regarded a helpful part, even though they might have lost focus at a particular moment. Also certain elements might soon become relevant to the user or might soon get focus. Because of the very constrained screen area certain techniques have to be applied to make or keep the user aware of these elements. Techniques that are proposed by the inventor are, e.g., 2.5 and 3D animation and movement of GUI elements, resizing and changing contrast of GUI elements to their background. Another aspect of the invention is a technique proposed to make GUI elements natural parts of their GUI screen background. For example unobtrusive tool buttons 306 are present in the background and natural parts of the background until the user decides he/she needs a tool. The tool buttons 306 are currently unobtrusively present since, e.g., it is anticipated that the user needs them soon. As pointed out earlier, this can be a consequence of a hierarchical menu with layers of sub-menus. A tool might very well be used in one of the next user actions. In yet another example, palette tool 210 of GUI 200 can physically not be present in its selectable condition because of the competing presence of the content (which here takes precedence). Therefore it has been resized to lost focus palette tool 310. Due to its new size the buttons of the lost focus palette tool 310 are not labeled any more. Depending on resources available for the GUI, the transition of tool 210 to lost focus palette tool 310 can be achieved with an animation movement and/or a dynamic resizing animation.

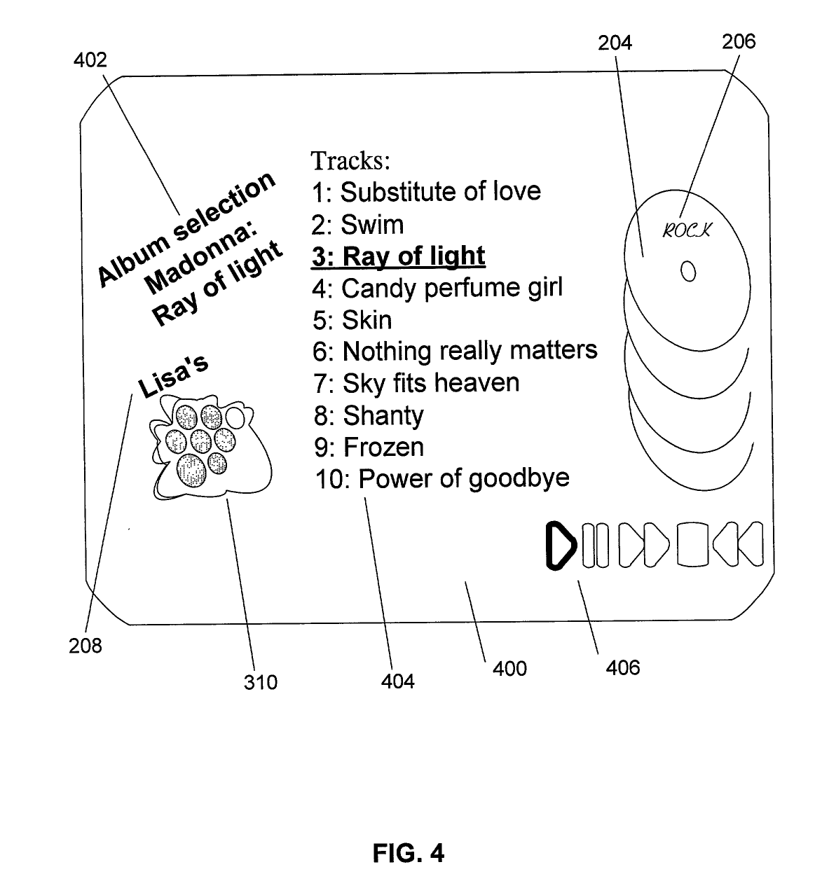

FIG. 4 is a schematic diagram illustrating a GUI screenshot 400 when content is being played. Parts of screenshot 400 are a text feedback 402, a physical anchor 204, a genre 206, an owner 208, a lost focus palette 310, a user selection 404 and an active transport indicator 406.

In screenshot 400 the user is given unambiguous feedback by highlighting an element from the transport indicator 406, in this example the play function. Text feedback 402 and user selection 404 provide textual feedback to the user. In screenshot 400 the name of the user/owner is shown using owner 208.

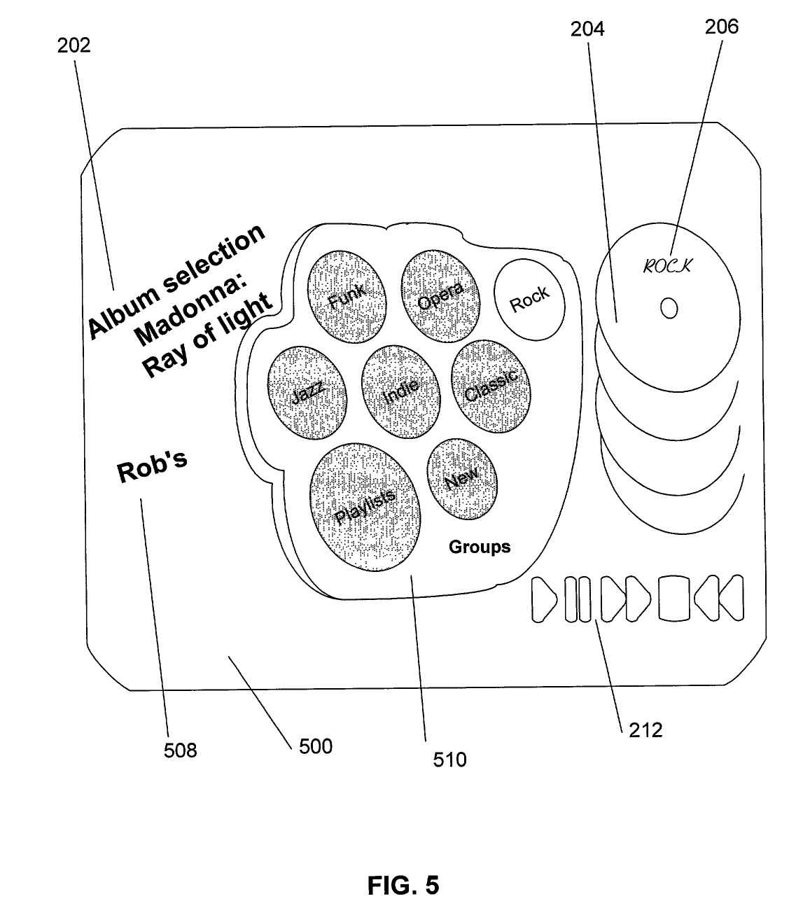

FIG. 5 is a schematic diagram illustrating a GUI screenshot 500 with the palette tool flipped around. Parts of screenshot 500 are a text feedback 202, a physical anchor 204, a genre 206, an owner 508, a palette tool 510 and a transport indicator 212.

In screenshot 500 the palette tool 510 has two sides/views. It is however important to give the user the illusion of the existence of other view. In screenshot 500 this is achieved by showing a slightly tilting palette tool 510. Another example of giving the user the illusion of the existence of other views would be the use of tabs (not visualized). When changing from one view of the palette tool 510 to another view the user can also be made aware of the other side, e.g., by means of animation in which the palette tool is flipped smoothly. It is also possible to extend the number of views to a higher number.

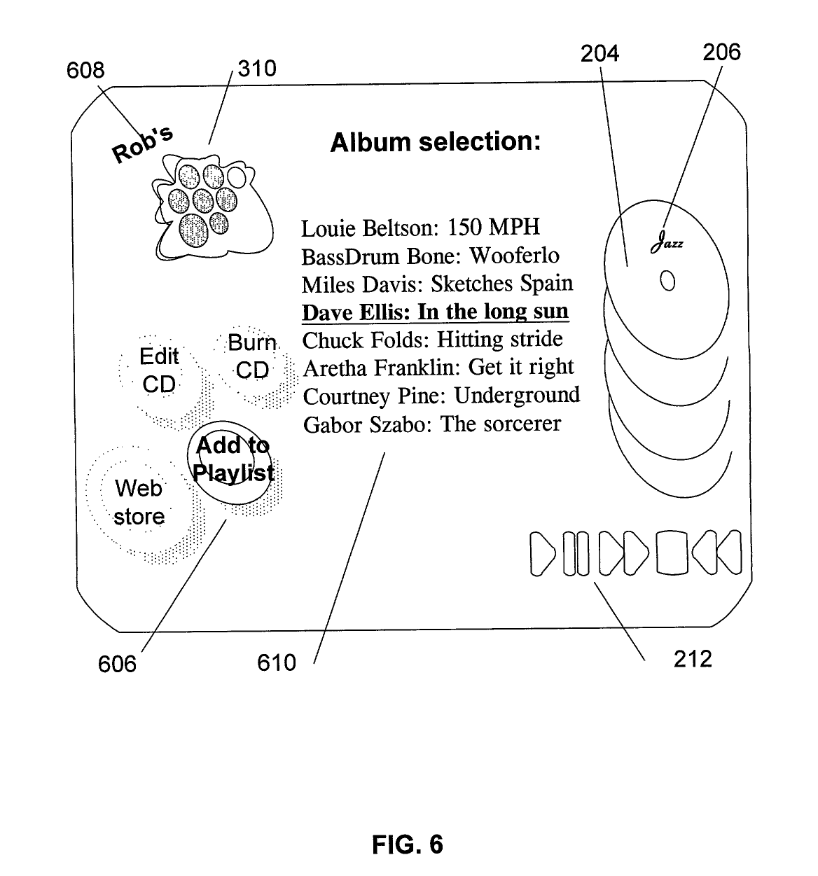

FIG. 6 is a schematic diagram illustrating a GUI screenshot 600 with a highlighted function menu. Parts of screenshot 600 are an owner 608, a lost focus palette 310, a physical anchor 204, a genre 206, tool buttons 606, a user selection 610 and a transport indicator 212.

In screenshot 600 the button “add to playlist” of the tool buttons has gotten focus. This can be the result of a user action such as pressing functions button 110 on remote control 100. This as opposed to screenshot 300 where the tool buttons 306 are currently semi visible and can e.g., be even part of a background picture or pattern. In screenshot 600 the user now gets a clear feedback that certain tool buttons are available. For instance the contrast of tool buttons might be larger, the button that has currently focus might be highlighted and the user might be able to browse the buttons using cursor control keypad 104.

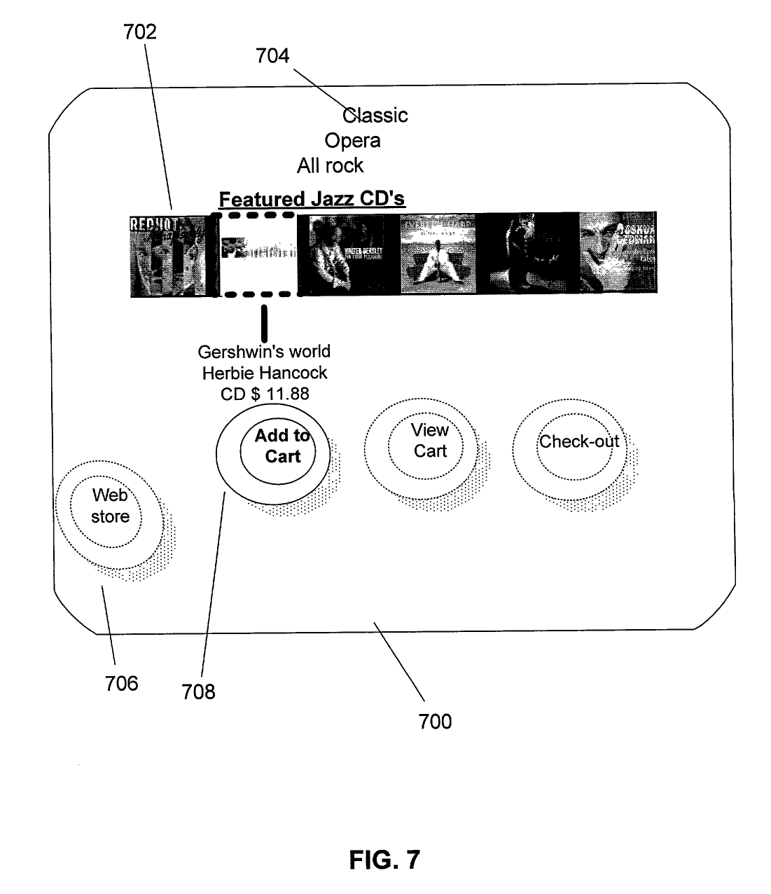

FIG. 7 is a schematic diagram illustrating a GUI screenshot 700 of the function Web store with some deeper level user options. Parts of screenshot 700 are a shop items bar 702, similar shop items 704, a Web-store button 706 and a Web-store button sub-menu 708.

Screenshot 700 might be a next screen after the user browsed over tool buttons 606 and pressed the OK button106 when the button “Web-store” was highlighted. The user's focus can now be to make a selection from merchandise displayed in items bar 702. As a consequence, GUI screenshot 700 mainly show elements relevant to the current user's focus although certain user options might still be semi visible parts of the background.

What is claimed is:

1. A method of displaying a menu with a GUI for representing a plurality of user-controllable options, comprising:
at least two sub-menus,
wherein:
a user can select a specific one of the sub-menus;
upon selection, the specific sub-menu is graphically represented in a prominent manner and another sub-menu is graphically represented in an unobtrusive manner.

2. The method of claim 1, wherein said unobtrusive manner is achieved by using at least one of the following techniques:
representing the other sub-menu with a higher degree of semi-transparency, compared to the specific sub-menu, with respect to a background;
representing the other sub-menu with a lower degree of contrast and the specific menu with a higher degree of contrast.

3. The method of claim 1, wherein said unobtrusively manner is achieved by displaying said other sub-menu as being part of at least:
a background motive;
a background graphics art.

4. The method of claim 1, wherein said unobtrusive manner is achieved by using at least one of the following techniques:
representing the other sub-menu using a smaller size and the specific sub-menu with a bigger size;
representing the other sub-menu using fewer details and the specific menu using more details.

5. The method of claim 4, wherein a pictorial graphical representation is used for displaying the other sub-menu.

6. A data processing device with a GUI for representing a plurality of user-controllable options, comprising:
at least two sub-menus, wherein:
a user can select a specific one of the sub-menus;
upon selection, the specific sub-menu is graphically represented in a prominent manner and an other sub-menu is graphically represented in an unobtrusive manner.

7. The data processing device of claim 6, wherein said unobtrusive manner is achieved by using at least one of the following techniques:
representing the other sub-menu with a higher degree of semi-transparency, compared to the specific sub-menu, with respect to a background;
representing the other sub-menu with a lower degree of contrast and the specific menu with a higher degree of contrast.

8. The data processing device of claim 6, wherein said unobtrusively manner is achieved by displaying said other sub-menu as being part of at least:
a background motive;
a background graphics art.

9. The data processing device of claim 6, wherein said unobtrusive manner is achieved by using at least one of the following techniques:
representing the other sub-menu using a smaller size and the specific sub-menu with a bigger size;
representing the other sub-menu using fewer details and the specific menu using more details.

10. The data processing device of claim 9, wherein a pictorial graphical representation is used for displaying the other sub-menu.

11. A method of enabling a user to interact with a GUI for representing a plurality of user-controllable options, comprising:
at least two sub-menus, wherein:
a user can select a specific one of the sub-menus;
upon selection, the specific sub-menu is graphically represented in a prominent manner and an other sub-menu is graphically represented in an unobtrusive manner.

12. The method of claim 11, wherein said unobtrusive manner is achieved by using at least one of the following techniques:
representing the other sub-menu with a higher degree of semi-transparency, compared to the specific sub-menu, with respect to a background;
representing the other sub-menu with a lower degree of contrast and the specific menu with a higher degree of contrast.

13. The method of claim 11, wherein said unobtrusively manner is achieved by displaying said other sub-menu as being part of at least:
a background motive;
a background graphics art.

14. The method of claim 11, wherein said unobtrusive manner is achieved by using at least one of the following techniques:
representing the other sub-menu using a smaller size and the specific sub-menu with a bigger size;
representing the other sub-menu using fewer details and the specific menu using more details.

15. The method of claim 14, wherein a pictorial graphical representation is used for displaying the other sub-menu.

16. A SW application for representing a GUI for displaying a plurality of user-controllable options, comprising:
at least two sub-menus, wherein:
a user can select a specific one of the sub-menus;
upon selection, the specific sub-menu is graphically represented in a prominent manner and an other sub-menu is graphically represented in an unobtrusive manner.

17. The SW application of claim 1, wherein said unobtrusive manner is achieved by using at least one of the following techniques:
representing the other sub-menu with a higher degree of semi-transparency, compared to the specific sub-menu, with respect to a background;
representing the other sub-menu with a lower degree of contrast and the specific menu with a higher degree of contrast.

18. The SW application of claim 1, wherein said unobtrusively manner is achieved by displaying said other sub-menu as being part of at least:
a background motive;
a background graphics art.

19. The SW application of claim 1, wherein said unobtrusive manner is achieved by using at least one of the following techniques:
representing the other sub-menu using a smaller size and the specific sub-menu with a bigger size;
representing the other sub-menu using fewer details and the specific menu using more details.

20. The SW application of claim 4, wherein a pictorial graphical representation is used for displaying the other sub-menu.
